(19) United States
(12) Patent Application Publication
(10) Pub. No.: US 2022/0135319 A1
(43) Pub. Date: May 5, 2022

(54) BOTTOM ASSEMBLIES FOR COMMERCIAL WASTE CONTAINERS

(71) Applicant: Plastic Recovery Technologies Corporation, Schaumburg, IL (US)

(72) Inventor: Kevin Paul Gavin, Northbrook, IL (US)

(21) Appl. No.: 17/454,184

(22) Filed: Nov. 9, 2021

Related U.S. Application Data
(63) Continuation-in-part of application No. 16/684,293, filed on Nov. 14, 2019, now abandoned.

(51) Int. Cl. B65F 1/14; B23K 33/00

(52) U.S. Cl. CPC B65F 1/14; B65F 2220/101; B65F 2250/112; B23K 33/00

(57) ABSTRACT

The present disclosure provides a replacement bottom kit and system that is adaptable to a wide range of designs, makes, and sizes of commercial waste containers or dumpsters that are currently in use. This will significantly reduce the complexity and cost of the refurbishing process and provide significant long-term environmental benefits. A replacement bottom kit for a dumpster may include a dumpster bottom piece comprising low carbon steel, the dumpster bottom piece including four sides integral with the dumpster bottom piece and bent at approximately 75-90 degrees with respect to the bottom and wherein the size of the dumpster bottom is about 72-73 inches on one side and from about 24 inches to about 52 inches on another side, a corner bracket, and a quick release caster pad.

### CROSS REFERENCE TO RELATED APPLICATIONS

This application is a continuation in part of U.S. Ser. No. 16/684,293 filed on Nov. 14, 2019, which is herein incorporated by reference in its entirety.

### BACKGROUND OF THE DISCLOSURE

### FIELD OF THE INVENTION

The present disclosure relates to a replacement assembly kit and system for refurbishing commercial waste containers or dumpsters particularly the bottoms.

### DESCRIPTION OF THE RELATED ART

Commercial waste containers, including dumpsters, are presently in use by a variety of establishments. It has not always been appreciated, however, that the bottom of a dumpster suffers the most wear and damage during normal use. Accordingly, very little has been done in terms of the development of a universal replacement bottom for a dumpster. This would allow an existing dumpster to be refurbished achieving a significantly longer lifetime, and which would provide significant environmental benefits and long-term cost savings.

The body of commercial waste containers or dumpsters can last ten to twelve years but because of the combined weight of a full container and real-life working conditions of lifting to transfer waste to a haul vehicle and the subsequent placement of the container on the ground, there are several high-wear parts on a container including the base or bottoms. Additionally, waste contents with high acid and/or salt content will accelerate the need to replace the steel bottom. Over the course of the life of a container, a container may be refurbished with the replacement of high wear parts including the bottoms.

The existing way to refurbish a container bottom is to replace with a bottom that is the exact size of the container to be refurbished. While there are some industry standard sizes for commercial waste containers, but there are hundreds of variations. Due to the weight and the associated cost of shipping long distances, container fabricators are generally regionally located, and regional differences in shapes and features also apply.

The current state of the art includes a significant number of types and sizes of commercial waste containers or dumpsters and highlights the significant complexity of refurbishing defective bottoms for commercial waste containers or dumpsters due to the various designs and sizes currently in use.

In some regions, the product solutions for replacement dumpster bottom are either 4″ and/or 2.5″ riser plain pans, or one would have to purchase flat sheets of steel and shear/bend the sheets which is a time-consuming process with double the welding length vs replacement bottom. Many dumpsters are stored in corrals, so standard sizes require casters for a waste driver to move the container from the corral before being able to reach and dump it in a front load truck. Many container repairs simply weld the caster to the bottom of the plain pan. Therefore, if a caster breaks or has a problem, the complete container will have to be brought back to the shop to remove the welds/caster and re-weld on a new caster. Thus, for a low-cost caster, a waste hauler will have to go through a round trip costing several hundred dollars including bringing the container back to the container repair shop and returning to the customer site.

### SUMMARY OF THE INVENTION

In embodiments a replacement bottom kit for a dumpster includes a dumpster bottom piece comprising low carbon steel, the dumpster bottom piece including four sides integral with the dumpster bottom piece and bent at approximately 75-90 degrees with respect to the bottom and wherein the size of the dumpster bottom is about 72-73 inches on one side and from about 24 inches to about 52 inches on another side, a corner bracket, and a quick release caster pad.

It is an object of the present disclosure to provide a replacement bottom kit and system that is adaptable to a wide range of designs, makes, and sizes of commercial waste containers or dumpsters that are currently in use. This would significantly reduce the complexity and cost of the refurbishing process and provide significant long-term environmental benefits.

This and other objects may be achieved by providing a two-piece base assembly which can be adjusted to fit a wide variety of commercial waste containers. Currently, the only way to replace the bottom of a commercial waste container is to fabricate a specific-sized base or bottoms and then to affix the base or bottom to the commercial waste container to be refurbished after the defective bottom has been removed.

There are hundreds of variations of commercial waste containers in use. A Universal Replacement Kit will substantially reduce the complexity of the refurbishing process and significantly reduce the cost. Furthermore, significant environmental benefits will be achieved by extending the lifetime of existing commercial waste containers and dumpsters.

Furthermore, in one embodiment, the design will allow the waste container bottom replacement kit to be nested in a compact configuration which will substantially reduce the size of a kit for shipping, and substantially reduce shipping cost.

Other features and aspects will be apparent from the following detailed description, the drawings, and the claims

### BRIEF DESCRIPTION OF THE DRAWINGS

FIG. 1A shows an isometric view of one embodiment of a replacement bottom for kit.

FIG. 1B shows one embodiment of a top view of a replacement bottom.

FIG. 1C shows one embodiment of a front view of a replacement bottom.

FIG. 2A shows an isometric view of one embodiment of a cap piece.

FIG. 2B shows a top view of one embodiment of a cap piece.

FIG. 2C shows a front view of one embodiment of a cap piece.

FIG. 3A shows a front view of one embodiment of an end cap.

FIG. 3B shows a view of one embodiment of an end cap.

FIG. 3C shows a side view of one embodiment of an end cap.

FIG. 4A shows an isometric view of one embodiment of a rail.

FIG. 4B shows a front view of one embodiment of a rail.

FIG. 4C shows a sectional view of one embodiment of the side of a rail.

FIG. 5A shows one embodiment of an assembled enhanced commercial waste container with load rail.

FIG. 5B shows a front view of one embodiment of an assembled enhanced commercial waste container with load rail.

FIG. 5C shows a bottom view of one embodiment of an enhanced commercial waste container load rail assembled to a replacement bottom assembly.

FIG. 6A shows how the end cap pieces are stacked inside replacement bottom with 2 rails.

FIG. 6B shows another replacement bottom placed on top to create a nesting/stacking of 2 full Universal Replacement Bottom Assembly Kits.

FIG. 6C shows a stack of 10 Universal Replacement Bottom Assembly Kits ready for shipment.

FIG. 7 shows embodiments of a quick release caster pad and corner bracket of the disclosure.

FIG. 8 shows another embodiment of a quick release caster pad of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The present disclosure relates to commercial waste container bottom assembly kits, capable of fitting a wide range of waste container and dumpster sizes. The systems include features such as an enhanced commercial waste container load rail and end caps which are included for both safety and durability reasons. The advantages over traditional methods of replacing container bottoms for odd size containers are significant.

### Adjustable Size Bottom Replacement Kits

With the disclosed bottom assembly kit, a container refurbisher conducting refurbishing's will be able to stock just a few sizes of the kit but, nevertheless, refurbish a wide range of designs and sizes of commercial waste containers or dumpsters. In addition, there will be significant savings in freight as the kit design allows for quantities to be nested into an optimal size for shipping, thus saving freight cost. In an effort to standardize replacement bottoms, a two-piece assembly capable of being sized to various containers is disclosed.

The pieces for the kits may be made of any material commonly used for a commercial waste container or dumpster. In one embodiment, steel is preferred. Steels which are generally used for dumpsters are contemplated; including carbon steels, alloy steels, galvanized steels, hot rolled steel, cold rolled steel, low carbon steel generally, roll-formed low carbon steel for the durable rail and kit parts, certified domestic steel, steels which meet any of the grades set by Society of Automotive Engineers and/or The American Society for Testing and Materials. See e.g., Steel, Wikipedia, the free encyclopedia, last edited 3 Nov. 2021, herein incorporated by reference. The steel may preferably be 11 gauge.

In embodiments, an adjustable size dumpster bottom replacement kit includes one or more dumpster bottom pieces, one or more dumpster cap pieces, and one or more load rails. Optionally, the kit may further include one or more cap end pieces. The dumpster bottom pieces and Pieces are variously sized and can be mixed and matched to fit a particular, existing, dumpster container. The dumpster bottom pieces and cap pieces can have “risers” or sides that are preconfigured or bent at an approximately 90° angle from the bottom for convenient installation. The riser may also be approximately 90% bent to allow easier fitting onto a container. In embodiments, the bends may be approximately 75-90 degrees with respect to the flat bottom.

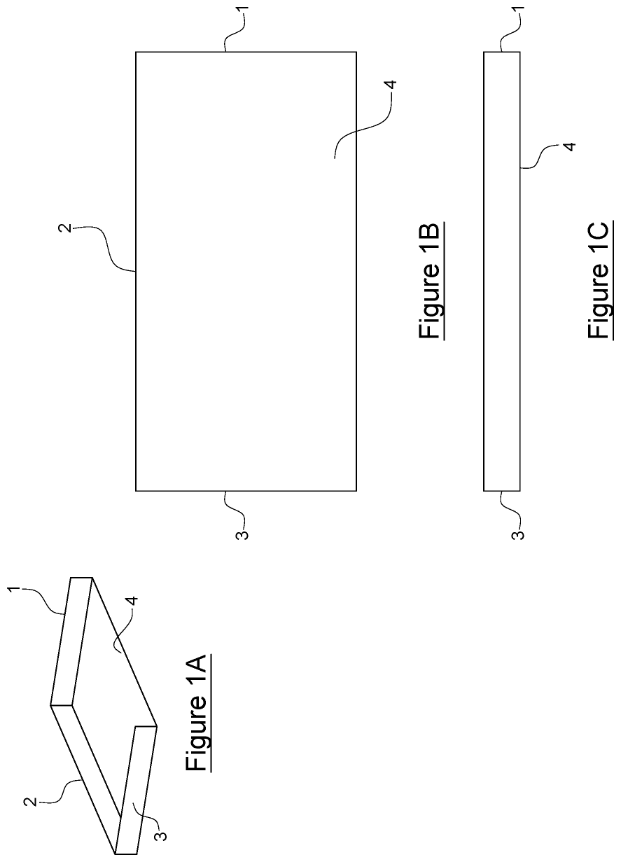

FIG. 1A shows a design for a bottom piece 1 for a kit for various container sizes. Bottom piece 1 includes sides 1, 2, and 3, and bottom 4. FIG. 1B shows a top view of bottom piece 1 for a kit shown in FIG. 1A. Sides 1, 2, and 3, can be provided in various lengths to suit various commercial waste container designs and sizes.

As one example, the length of side 2 may be about 73 inches and the length of side 3 may be about 36 inches to suit a particular, standard, commercial waste container size. In other embodiments, the length of side 2 may be about 73 inches and the length of side 3 may be about 54 inches to suit other, standard, commercial waste container sizes. The length of side 3 may also range up to 72 inches or 90 inches. The above dimensions are provided only as examples and a variety of lengths is contemplated in order to fit a wide variety of commercial waste container designs and sizes. One kit may provide bottom and cap pieces to fit a standard 2 YD, 3 YD, or 4 YD (about 36 inch to about 54 inch) container or dumpster; or a standard 6 YD or 8 YD (about 54 inch to about 72 inch) container/dumpster; or a standard 8 YD or 10 YD (about 72 inch to about 90 inch) container or dumpster.

A kit may fit dumpster sizes of 72.5 inches×38-42 inches (2 YD); 72.5 inches×48-54 inches (3 YD and 4 YD); 72.5 inches×55-60 inches (4 YD and 6YD); 72.5 inches×61-66 inches (6 YD); 72.5 inches×67-72 inches (6 YD and 8 YD; 72.5 inches×73-80 inches (8 YD).

Accordingly, in embodiments, the length of a side may range from about 36 inches to about 90 inches, or from about 36 inches to about 54 inches or from about 54 inches up to about 72 inches or from about 72 inches up to about 90 inches. In some preferred embodiments the width may be about 58″ or about 61″.

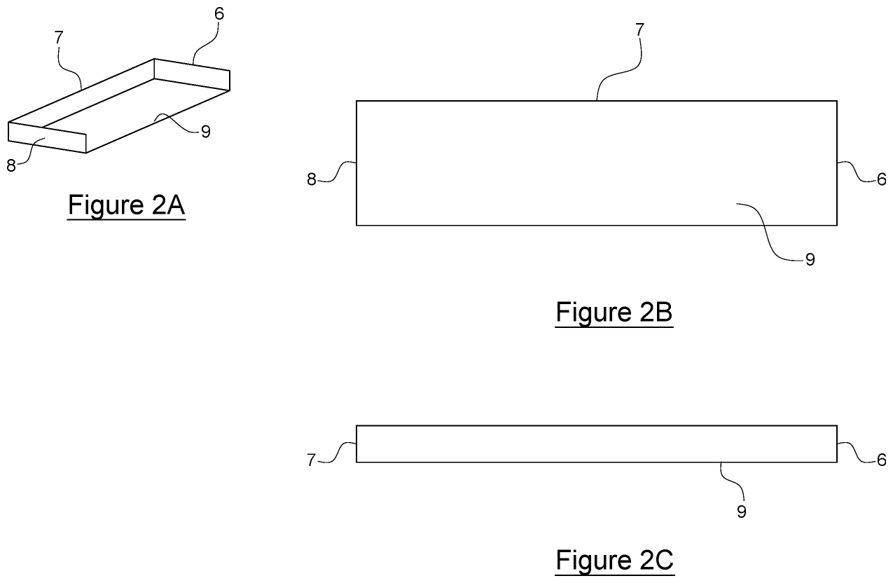

FIG. 2A shows a cap piece 5, with sides 6, 7, and 8, and bottom 9, which may be welded to bottom piece 1 once sized to the container. Cap piece 5 can be moved to the exact size of a non-standard container and welded into the exact size as necessary.

FIG. 2B shows a top view of cap piece 5. FIG. 2C shows a front view of cap piece 5. In one example, side 7 of cap piece 5 may be about 72.5 inches and side 8 may be about 12 inches to 36 inches, in one preferred embodiment about 19 inches. The height of one of the sides 6, 7, or 8 can range from about 3-12 inches and may preferably be about 5-6 inches. These dimensions are provided only as examples and a variety of dimensions are contemplated as appropriate.

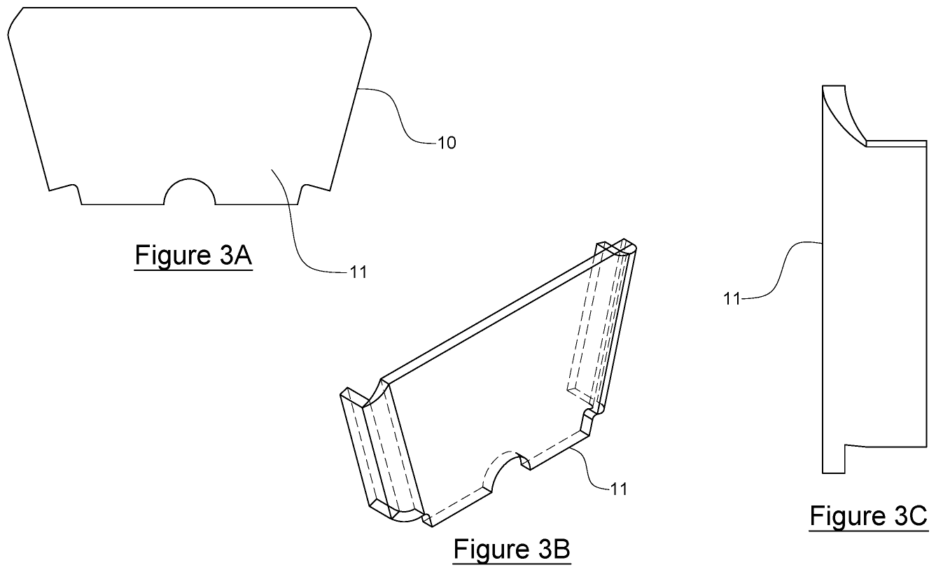

FIG. 3A shows an enhanced commercial waste container load rail 10, with connected end caps 11, and which may be fixed to bottom piece 1. FIG. 3B shows a view of end cap 11. FIG. 3C shows a side view of end cap 11.

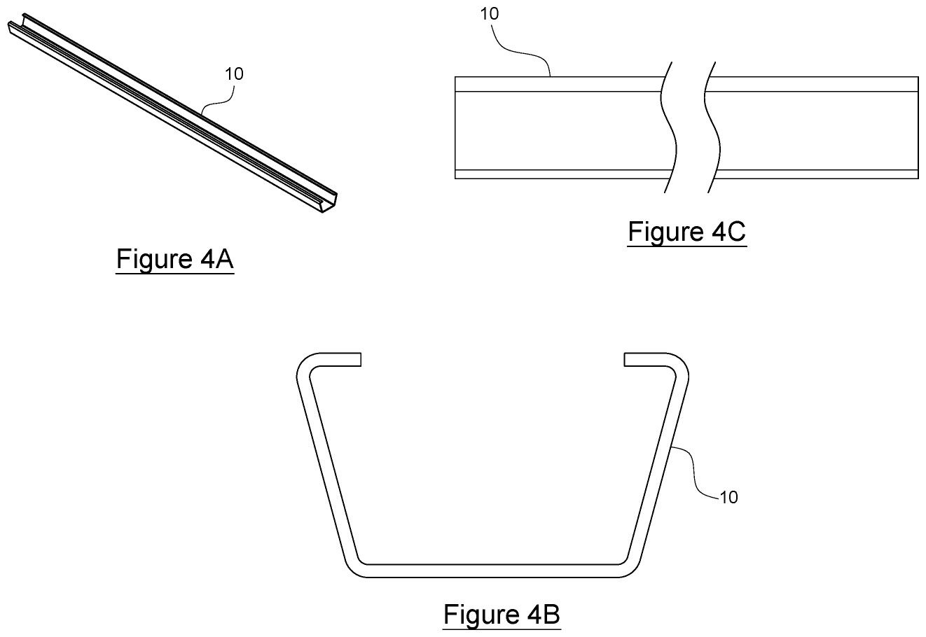

FIG. 4A shows an overview of the enhanced commercial waste container load rail 10. FIG. 4B shows a front view of load rail 10. FIG. 4C shows a sectional side view of load rail 10.

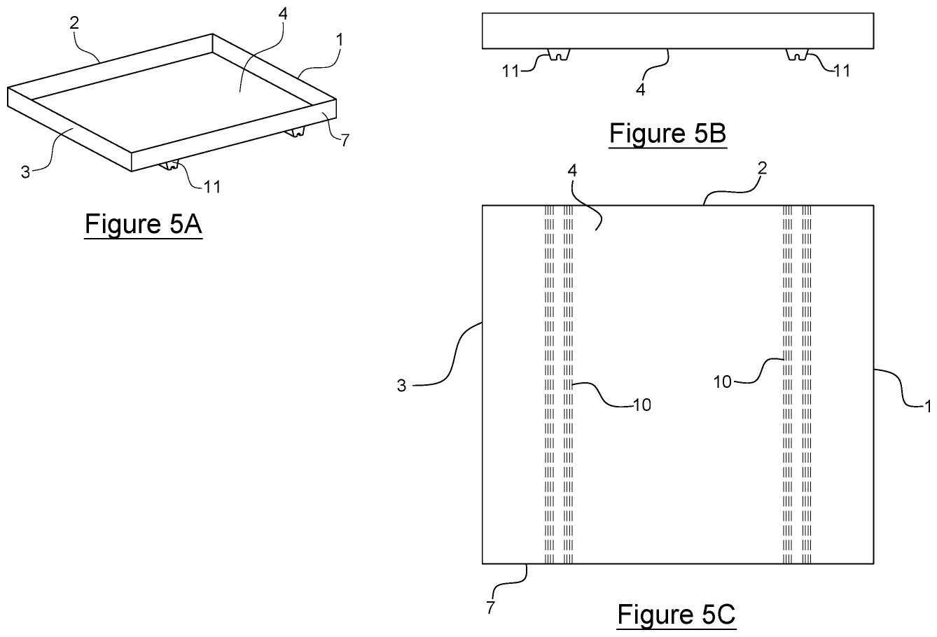

FIG. 5A shows one embodiment of a replacement bottom kit assembly in assembled form including bottom piece 1, cap piece 5, showing 2 rails and end caps. The preferred method of assembly is welding. FIG. 5B shows a front view of an assembled bottom kit assembly. FIG. 5C shows a bottom view of an assembled bottom kit assembly.

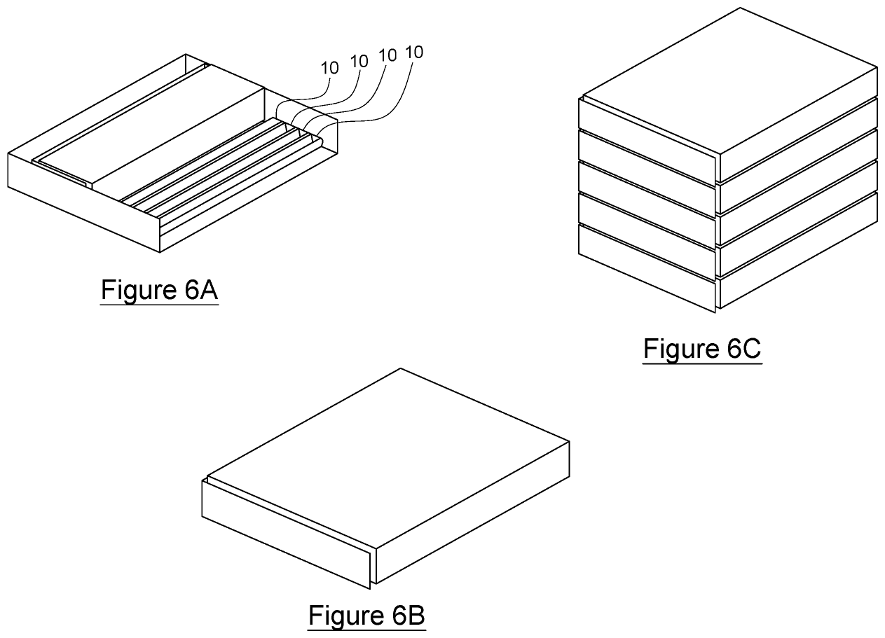

FIG. 6A shows the stacking/nesting of two Universal Replacement Bottom Assembly Kits allowing for the 90% bends to maintain during shipping for ease of installing kit onto container by a refurbisher, this view has one bottom cap 1 piece removed to show how the nesting of 4 rails 10 and 2 cap piece 5 occurs inside. FIG. 6B shows how the Universal Replacement Bottom Assembly Kits are combined in pairs of two nested inside 2 Bottom Piece 1 to minimize the footprint and freight costs. FIG. 6C show the completed bundle of 10 Universal Replacement Bottom Assembly Kits nested as 5 pairs stacked and ready for shipping.

In embodiments, the disclosure also includes methods of replacing a dumpster bottom with an adjustable size bottom kit. The method includes positioning a dumpster cap piece firmly in place against the back of a container or dumpster. Sliding a dumpster bottom piece inward toward the cap piece creating a bottom that fits the specific container. The seams between the bottom piece and cap piece, and between the dumpster and risers, are tack welded. A complete full weld of the risers and bottom seam is completed. Optionally, load rails may be trimmed to a particular desired length. The load rails are then positioned in place, optionally about 12 inches from each outer edge of a dumpster container, and then welded into place.

### Fixed Size Replacement Bottoms

The disclosure is further directed to standardizing a fixed size replacement bottom with an approximately 4″ riser bend along with 4 corner brackets which provide greater support and including quick release caster pads welded on the brackets. The plated casters can then be easily inserted into the caster pad and casters can easily be changed on-site. In addition, the bottoms with 90% bends are very easy to install and require half the welding that flat sheet repairs take.

The fixed bottom replacement comes in various dumpster size configurations with corner brackets for increased durability and quick release caster pads that reduce standard repair time for a bottom installation. The sizes include about 72.5″ wide by about 24″ long (1 yard container); about 72.5″ wide by about 30″ long (1.5-yard container); about 72.5″ wide by about 35″ long (2 yard container); about 72.5″ wide by about 42.5″ long (3 yard container); and about 72.5″ wide by about 51.5″ long (4 yard container).

Accordingly, in embodiments, the size ranges from about 70-73 inches wide and about 20 inches to about 55 inches long. Preferably the size ranges from about 72 inches wide and about 24 inches long to about 52 inches long. The 1 yard, 1.5 yard, 2 yard, 3 yard, and 4 yard containers are preferred embodiments.

A 90% bent riser preserved with the packaging makes it much more efficient to fit on a container since pushing bowed risers is eliminated and not necessary. Efficient, dense packaging provides much more cost-effective shipping rates and allows for efficient storage in a repair yard/shop.

Installing quick release caster pads eliminates the costly process of having to return a dumpster to a container shop for repair of a caster. The bottom replacement for the 5 sizes mentioned above can be made for order so service levels are greatly improved with shipping done in 24 hours vs waiting a month or longer for a product built to order as is commonly done in the art.

Vastly improved standard repair times (SRT) are the result in dumpster bottom replacement since the bottoms include assemblies of corner brackets and caster pads. In addition, the 90% bends of the bottoms allow the replacement bottom to more efficiently be welded onto an old container. Efficient, dense packaging is also much more cost effective and reduces shipping rates and allows for efficient storage in the customer repair yard/shop.

The product may be made from steel as described above. In a preferred embodiment the steel may be 11 gauge providing enhanced strength and durability. The corner bracket provides strength and durability but does not interfere with the nesting/stacking of the bottoms allowing up to 14 per stack and allows safe transport.

The components on the bottom can vary with corner brackets, caster pads, and potentially casters and fork channels. Some regional containers are lifted by a front load truck using fork channels located on the bottom versus the side(s) of the container. Packaging includes metal corner supports, metal strapping to keep the bottoms secure during transport and channels on the last bottom can be tac welded to allow for 4-way entry for fork truck for ease of loading/unloading and for the customer transporting in a container yard.

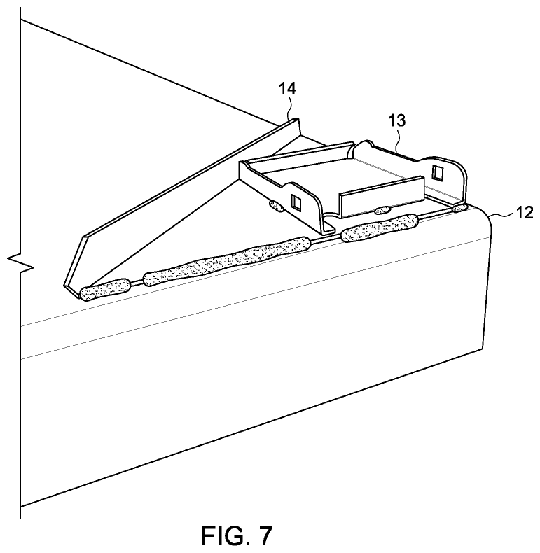

FIG. 7 shows embodiments of a quick release caster pad and corner bracket of the disclosure. FIG. 7 shows dumpster bottom 12, caster pad 13, and corner bracket 14.

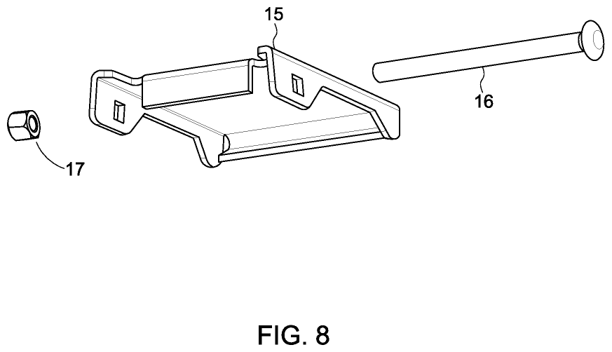

FIG. 8 shows another embodiment of a quick release caster pad of the disclosure. FIG. 8 shows caster pad 15, bolt 16 and nut 17 for attaching a caster (not shown) to the caster pad.

A caster as used herein is a wheel attached to a metal plate that can be configured to fit onto a caster pad on the dumpster bottom to provide mobility to a dumpster. A caster pad is a component attached to the dumpster bottom that is configured to accept a caster. A quick release caster pad allows a caster to be securely and releasably attached to a dumpster bottom.

While this disclosure includes specific examples, it will be apparent after an understanding of the disclosure of this application has been attained that various changes in form and details may be made in these examples without departing from the spirit and scope of the claims and their equivalents.

1. A replacement bottom kit for a dumpster comprising:
a dumpster bottom piece comprising low carbon steel;
wherein the dumpster bottom piece comprises four sides integral with the dumpster bottom piece and bent at approximately 75 degrees to 90 degrees with respect to the bottom and wherein the size of the dumpster bottom is about 72-73 inches on one side and from about 24 inches to about 52 inches on another side;
a corner bracket; and
a quick release caster pad.

2. The replacement bottom kit for a dumpster of claim 1, wherein the dumpster bottom comprises two corner brackets.

3. The replacement bottom kit for a dumpster of claim 1, wherein the dumpster bottom comprises two quick release caster pads.

4. The replacement bottom kit for a dumpster of claim 1, wherein the size of the bottom of the dumpster is about 72.5 inches on one side and about 24 inches on another.

5. The replacement bottom kit for a dumpster of claim 1, wherein the size of the bottom of the dumpster is about 72.5 inches on one side and about 30 inches on another.

6. The replacement bottom kit for a dumpster of claim 1, wherein the size of the bottom of the dumpster is about 72.5 inches by about 35 inches.

7. The replacement bottom kit for a dumpster of claim 1, wherein the size of the bottom of the dumpster after welding is about 72.5 inches by about 42.5 inches.

8. The replacement bottom kit for a dumpster of claim 1, wherein the size of the bottom of the dumpster after welding is about 72.5 inches by about 51.5 inches.

9. The replacement bottom kit for a dumpster of claim 1, wherein the dumpster bottom further comprises fork channels.

10. The replacement bottom kit for a dumpster of claim 1, wherein the dumpster bottom and cap piece sides are approximately 4 inches high rising from the dumpster bottom or cap piece bottom.
